(19) United States
(12) Patent Application Publication
(10) Pub. No.: US 2013/0051031 A1
(43) Pub. Date: Feb. 28, 2013

(54) REFLECTIVE STREET LIGHT WITH WIDE DIVERGENCE ANGLE

(71) Applicants: Ching-Cherng Sun, Taoyuan County (TW); Yi-Chien Lo, Miaoli County (TW); Shih-Kai Lin, Tainan City (TW)

(72) Inventors: Ching-Cherng Sun, Taoyuan County (TW); Yi-Chien Lo, Miaoli County (TW); Shih-Kai Lin, Tainan City (TW)

(73) Assignee: National Central University, Taoyuan County (TW)

(21) Appl. No.: 13/222,896

(22) Filed: Aug. 31, 2011

(51) Int. Cl. F21V 5/00

(52) U.S. Cl. 362/311.06

(57) ABSTRACT

A reflective street light with wide divergence angle includes a light device having a Light emitter and a total reflection lens. The light rays from the light emitter are reflected to two sides of the total reflection lens and then are refracted outward via the refraction surfaces at maximum angle.

### BACKGROUND OF THE INVENTION

1. Field of the Invention

The present invention relates to a reflective street light, and more particularly to a reflective street light with wide divergence angle.

2. Description of Related Art

A conventional reflective street light includes an installation portion and a reflection portion. The installation portion is connected with a light emitter and the reflection portion has a film coated thereon so as to reflect the light. When the light emitter is activated by current and emits multiple light rays, the reflection portion reflects the light rays which go toward substantially the same direction so that the light rays directly light or are reflected to the area to be lighted.

However, the conventional reflective street light can only collect the light rays downward so that the emitting range of the light rays is limited. Therefore, the conventional reflective street light is not suitable for illuminating a wide range of area. The present invention provides a reflective street light with wide divergence angle, wherein the light rays are reflected to two sides of a lens and then refracted outward at maximum angle.

### SUMMARY OF THE INVENTION

The main objective of the present invention is to provide a wide divergence angle total reflection street light includes a light device having a light emitter and a total reflection lens. The light rays from the light emitter are reflected to two sides of the total reflection lens and then are refracted outward via the refraction surfaces at maximum angle.

To achieve the objective, the street light of the present invention comprises a light device having a light emitter and a total reflection lens. The total reflection lens has a recess defined in the first side thereof and the light emitter is located in the recess. The total reflection lens has two refraction surfaces respectively located on two sides thereof. A V-shaped and recessed reflection surface is defined in the second side of the total reflection lens and located facing the recess. The reflection surface reflects the light rays from the light emitter to the refraction surfaces so that the light rays are refracted outward via the refraction surfaces. The light rays from the light emitter are refracted via the refraction surfaces and the light rays scattering to the reflection surface are reflected to the refraction surfaces to reinforce illumination on sides of the light emitter.

Further benefits and advantages of the present invention will become apparent after a careful reading of the detailed description with appropriate reference to the accompanying drawings.

### BRIEF DESCRIPTION OF THE DRAWINGS

FIG. 1 shows the light traces of the light emitter and the total reflection lens of a reflective street light with wide divergence angle of the present invention;

FIG. 2 shows the total reflection lens of the reflective street light with wide divergence angle of the present invention, and

FIG. 3 shows the reflective street light with wide divergence angle of the present invention.

### DETAILED DESCRIPTION OF THE INVENTION

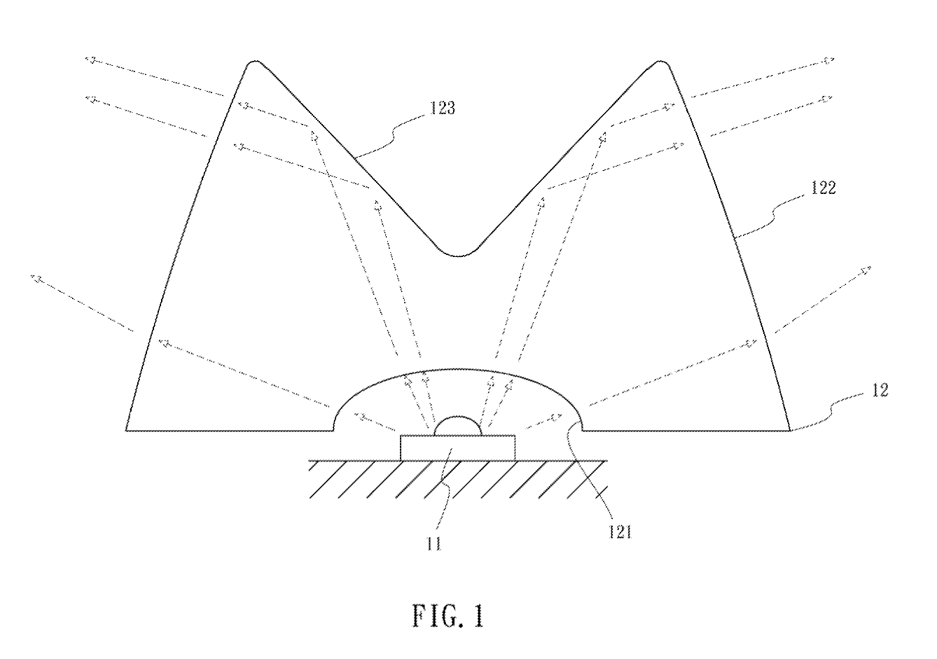

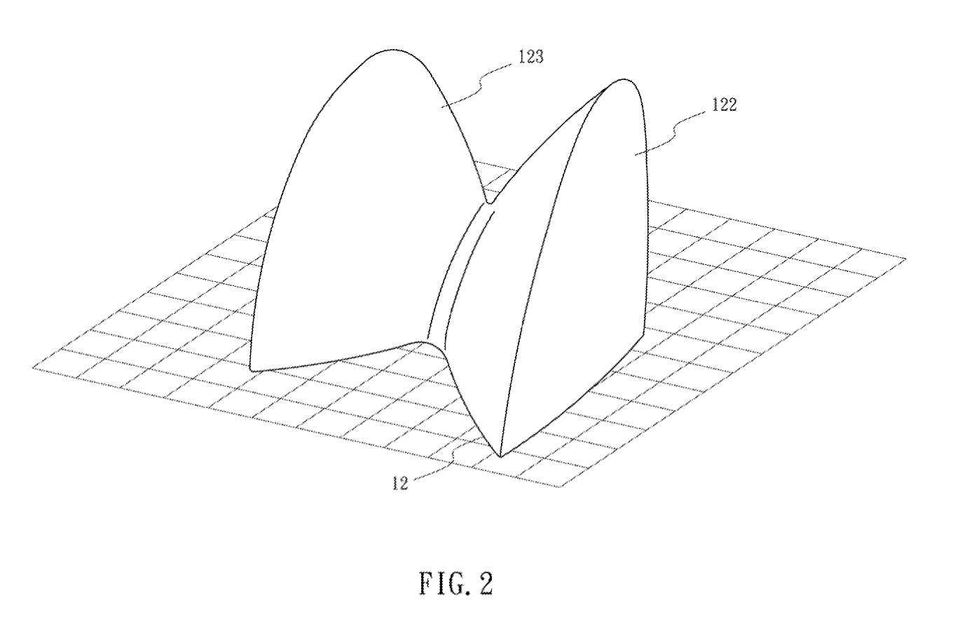

Referring to the drawings and initially to FIGS. 1 and 2, a reflective street light with wide divergence angle in accordance with to the present invention comprises a light device 10 having a light emitter 11 and a total reflection lens 12.

The total reflection lens 12 has a recess 121 defined in the first side thereof and the light emitter 11 is located in the recess 121. The total reflection lens 12 has two refraction surfaces 122 respectively located on two sides thereof. A V-shaped reflection surface 123 is defined in the second side of the total reflection lens 12 and located facing the recess 121. The reflection surface 123 reflects the light rays from the light emitter 11 to the refraction surface s 122 so that the light rays are refracted outward via the refraction surfaces 122.

The light rays from the light emitter 11 are directly refracted via the refraction surfaces 122 and the light rays scattering to the reflection surface 123 are reflected to the refraction surfaces 122 to reinforce illumination on sides of the light emitter 11.

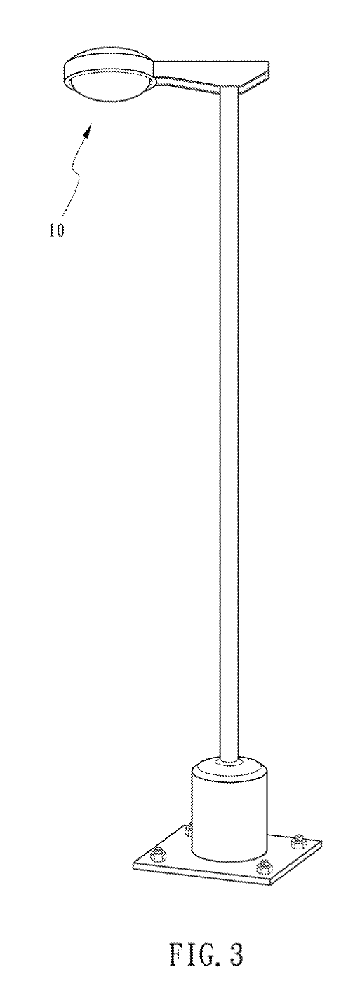

Referring to FIG. 3, the reflective street light with wide divergence angle of the present invention is used for street light, because the side illumination of the street light is expected by higher standard, the reflective street light with wide divergence angle of the present invention provides the wide divergence angle to pull the light of the traffic stream.

Although the invention has been explained in relation to its preferred embodiment, it is to be understood that many other possible modifications and variations can be made without departing from the spirit and scope of the invention as hereinafter claimed.

1. A reflective street light with wide divergence angle comprising:
a light device having a light emitter and a total reflection lens, the total reflection lens having a recess defined in a first side thereof and the light emitter located in the recess, the total reflection lens having two refraction surfaces respectively located on two sides thereof, a V-shaped and recessed reflection surface defined in a second side of the total reflection lens and located facing the recess, the reflection surface reflecting light rays from the light emitter to the refraction surfaces so that the light rays are refracted outward via the refraction surfaces;
therefore, the light rays from the light emitter is refracted via the refraction surfaces and the light rays scattering to the reflection surface are reflected to the refraction surfaces to reinforce illumination on sides of the light emitter, so that a divergence angle of the light rays is increased.
